(19) United States
(12) Patent Application Publication
(10) Pub. No.: US 2013/0030838 A1
(43) Pub. Date: Jan. 31, 2013

(54) Unified Medical Record Retrieval

(71) Applicants: Marina Myers, Grants Pass, OR (US); Stewart Myers, Philomath, OR (US)

(72) Inventors: Marina Myers, Grants Pass, OR (US); Stewart Myers, Philomath, OR (US)

(21) Appl. No.: 13/194,893

(22) Filed: Jul. 29, 2011

(51) Int. Cl. G06Q 50/00; G06Q 10/00

(52) U.S. Cl. 705/3

(57) ABSTRACT

A system and methods for accessing patient medical records from national and non-national healthcare system records databases are disclosed. A patient's medical record identifier is used to match medical records in a national healthcare system records database and in a non-national healthcare system records database. The matched records are returned to the requesting healthcare provider so that the provider may review the patient's complete healthcare history.

### BACKGROUND OF THE INVENTION

1. Field of the Invention

The present invention relates to medical records, and more specifically to a system and method for retrieving patient medical records from at least one of a national medical records database and a non-national medical records database.

2. Description of the Related Art

Having access to a patient's medical records is a critical component in providing effective healthcare. Medical records provide a summary of an individual's health history and are frequently used by healthcare practitioners to assess and monitor a patient's current condition. Without access to medical records, many providers would not be able to deliver adequate care to a patient.

Medical records that have been computerized or are stored in an electronic database are generally referred to as electronic medical records (EMRs). EMRs may be created and maintained independently by a plurality of healthcare providers, or may be unified under a common EMR system as in hospitals where different providers are responsible for different areas of a patient's care. Unification of EMRs under a common system offers the benefit that any provider with access to the system may view the most recent information and make healthcare decisions accordingly. Without access to contemporaneous healthcare information, providers may not be able to properly monitor a patient's condition. This is a great concern when patients are afflicted with aggressive diseases or rapidly advancing conditions.

EMRs generated by those providing immediate care to a patient reside in that provider's computer infrastructure where the provider, or their colleagues, may access them as needed. When a patient seeks care from providers not associated with each other, EMR access becomes difficult and important information may not be communicated.

There has been much discussion about implementing a universal or national healthcare system. Under this system, members of society would receive healthcare for little or no charge. Federal and state governments could be responsible for overseeing and administering this system across the nation. It is also possible that private companies or organizations would be contracted to implement a national healthcare system. As part of the national healthcare system, a national medical records database would be established that contains information about patients receiving care under the system.

Even though patients may be a part of a national health care system, they may still receive additional care from providers not associated with the national system. Patients may have medical records in the both the national healthcare system and with the non-associated providers. There may even be a plurality of national medical record databases in which a patient may have healthcare information. There is a need to quickly and easily gain access to all of a patient's medical records so that healthcare providers may effectively treat the patient. The present invention seeks to meet that need by allowing healthcare providers to retrieve patient records from one or more medical records systems.

### BRIEF SUMMARY OF THE INVENTION

An invention for retrieving patient medical records from one or more healthcare systems is disclosed. A single patient identifier is entered into a computer-based record retrieval system. The identifier contains information that uniquely identifies a particular patient. The retrieval system accesses both a national medical records database and a non-national medical records database. Records with identifiers matching the patient's identifier are retrieved from either database. The retrieved records are then displayed to the provider requesting access.

The identifier may be machine readable and may be stored in a magnetic strip as commonly found on credit cards. The identifier may also be stored in barcode format, or within an integrated circuit embedded within a card or other type of integrated circuit holder. The identifier may be stored in a radio frequency identification (RFID) device. The identifier may also be stored in any format that is suited for medical record retrieval. It may even be an existing numerical identifier associated with a patient such as their patient number, driver's license number, social security number, or a biometric indicator generated for that patient.

In one exemplary embodiment of the preferred invention, a medical record identifier is contained within a healthcare identification card. The identifier may be stored in a magnetic strip on the card, a barcode on the card, an integrated circuit within the card, or in any other device capable of storing the identifier. A healthcare provider that would like to access the patient's medical record would read the identifier into a computer that is connected to one or more national and non-national healthcare databases. The computer would use the identifier to locate and retrieve the patient's medical record from each of the databases and return the requested records to the requesting provider.

In another exemplary embodiment of the present invention, a medical record identifier would be a numeric, alphabetical, or alphanumeric string that a patient could convey verbally or in a written form to a healthcare provider.

In yet another exemplary embodiment of the present invention, a medical record identifier would be stored in a machine readable format within a healthcare provider's computer.

In yet another exemplary embodiment of the present invention, a medical record identifier would be stored in a machine readable format within a patient's computer. The patient's computer could include their smartphone, tablet, PC, laptop, netbook, and similar devices.

### BRIEF DESCRIPTION OF THE SEVERAL VIEWS OF THE DRAWING(S)

A further understanding of the present invention can be obtained by reference to a preferred embodiment set forth in the illustrations of the accompanying drawings. Although the illustrated embodiment is merely exemplary of methods for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

FIG. 1 is a block diagram of an exemplary unified method for retrieving medical records that may be used as according to one embodiment of the present invention;

FIG. 2 is a flowchart diagram of an exemplary unified method for retrieving medical records that may be used as according to one embodiment of the present invention;

FIG. 3 is a plan view of an exemplary card with a magnetic memory strip as according to one embodiment of the present invention;

FIG. 4 is a plan view of an exemplary card with a barcode as according to one embodiment of the present invention;

FIG. 5 is a plan view of an exemplary card with a quick response code as according to one embodiment of the present invention;

FIG. 6 is a plan view of an exemplary card with an integrated as according to one embodiment of the present invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

In a manner described below, the data processing aspects of the present invention may be implemented, in part, by programs that are executed by a computer. The term “computer” as used herein includes any device that electronically executes one or more programs, such as personal computers (PCs), hand-held devices, multi-processor systems, microprocessor-based programmable consumer electronics, network PCs, minicomputers, tablets, smartphones, mainframe computers, routers, gateways, hubs and the like. The term “program” as used herein includes applications, routines, objects, components, data structures and the like that perform particular tasks or implement particular abstract data types. The term “program” as used herein further may connote a single program application or module or multiple applications or program modules acting in concert. The data processing aspects of the invention also may be employed in distributed computing environments, where tasks are performed by remote processing devices that are linked through a communications network. In a distributed computing environment, programs may be located in both local and remote memory storage devices.

The term “patient” may be used interchangeably herein to refer to a single person, or to any plurality of persons for whom healthcare is contemplated. Although the following description and claims may refer to a patient in the singular, it is understood that “patient” may refer to patients in the multiple.

The term “provider” may be considered herein any individual, company, association, agency, partnership, organization or other entity that offers healthcare services to a patient.

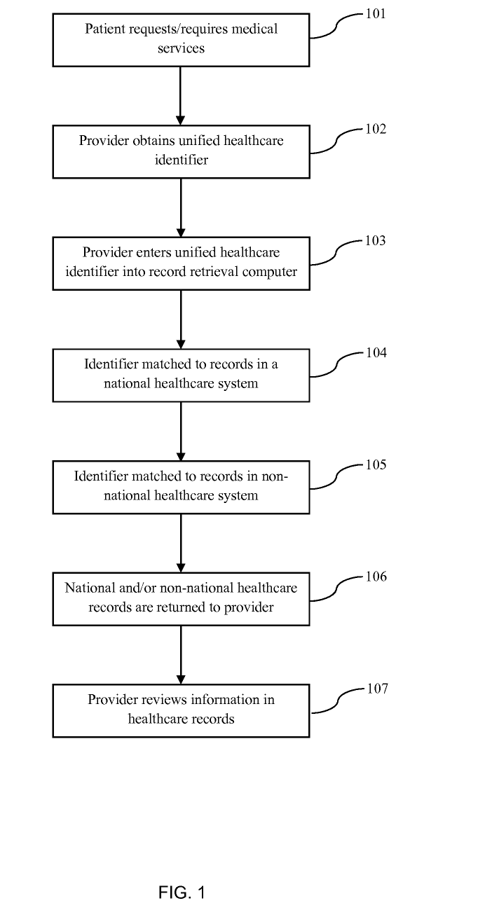

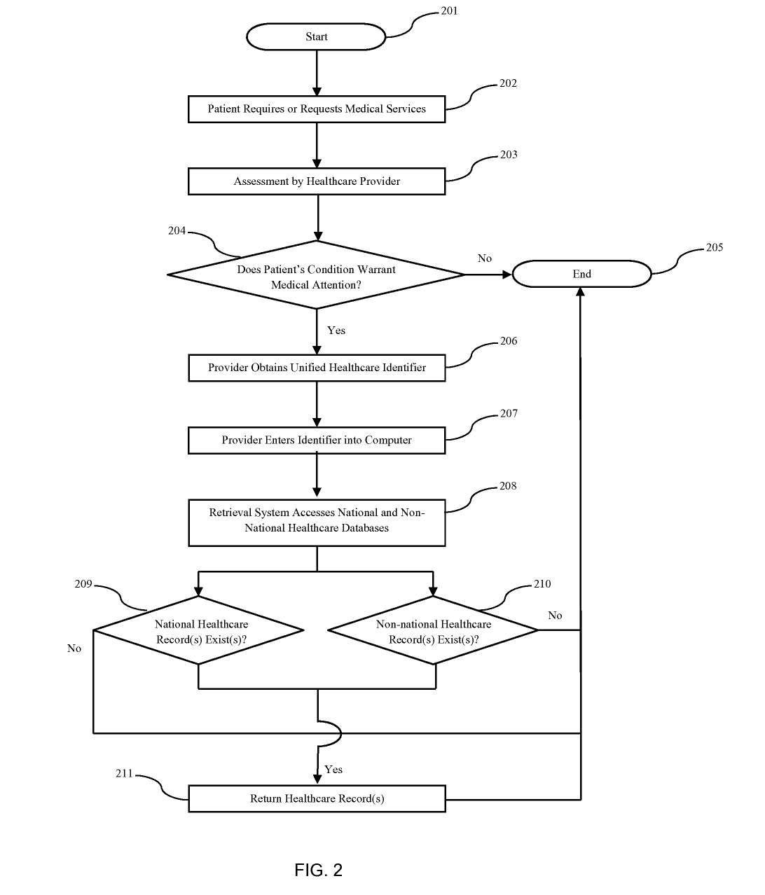

Referring now to FIGS. 1 and 2 that will be discussed together, there is shown an exemplary unified method for retrieving medical records that may be used as according to one embodiment of the present invention. A patient may request or may require healthcare attention (101, 202). To properly assess the patient's healthcare condition (203), a provider may decide to view the patient's medical history as described in their medical records. If the patient's condition warrants healthcare attention (204), the provider may obtain the patient's unified healthcare identifier (102, 206) and may enter the identifier into a computer capable of retrieving the medical records (103, 207). The computer may access a database that is associated with a national healthcare system (208) and may locate medical records with a matching identifier (104, 209). The computer may also access a medical records database that is not associated with a national healthcare system (208) and may locate medical records with a matching identifier (105, 210).

The computer may be an individual terminal, or may be a computer information system consisting of a plurality of computers that are that are connected through communications interfaces. Commonly, as is the case with Internet and intranet applications, computers are connected by network infrastructure that allow the computers to communicate with each other. This permits computers that are separated by geographic distances to interact with each other and retrieve information from databases that are geographically separated from the provider wishing to access the information.

Medical record databases that are not associated with a national healthcare system may include, but are not limited to, the medical records databases of private or public clinics, hospitals, surgeries, doctors, specialists, healthcare centers, healthcare centers, healthcare equipment suppliers, insurance companies, or any other healthcare provider that maintains medical records for a patient as part of a healthcare service that is not national healthcare.

After a patient's medical records have been located, the records may be returned to the requesting provider (106, 211). Return of the medical records may be by way of electronic transmission through a computer or computer network, by way of facsimile, or may be by way of non-electronic means such as the sending of tangible medical records through the mails. Upon receiving the returned medical records, the requesting provider may choose to review the information contained within the records (107).

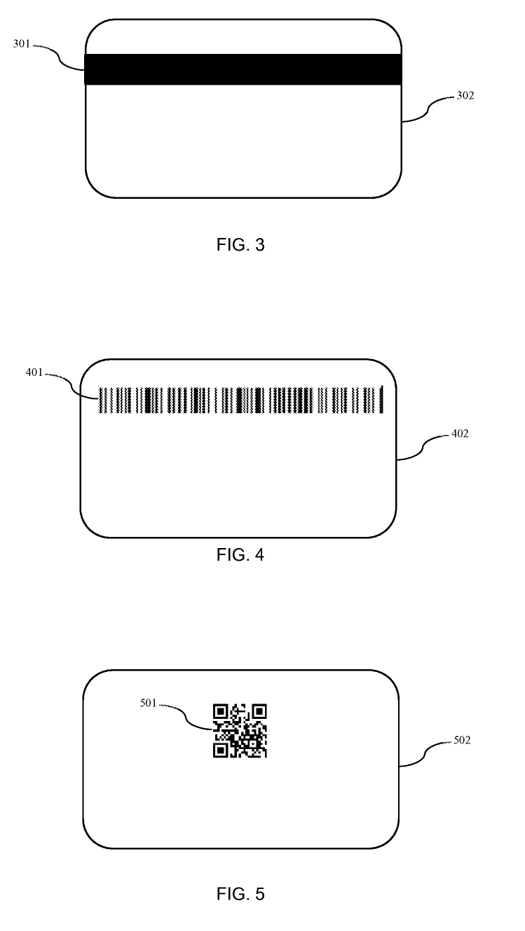

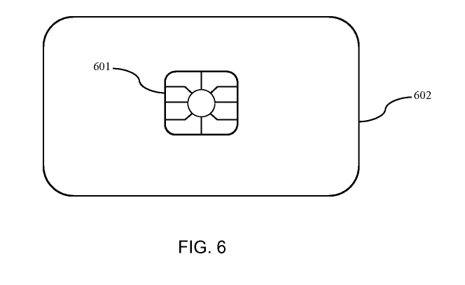

Referring now to FIGS. 3-6, that will be discussed together, there are shown exemplary medical records cards with devices for containing the patient's medical records identifier as according to one or more embodiments of the present invention. The cards (302, 402, 502, 602) may be of similar size and construction as traditional healthcare membership cards which are well known in the prior art. One embodiment of the present invention may be implemented by recording and storing a patient's medical record identifier in a magnetic stripe (301) that is located on the card (302). Magnetic stripes (301) are also well known in the prior art and operate by modifying the magnetism of iron-based particles within the stripe. The patient's medical record identifier may be read from the magnetic stripe (301) by swiping the stripe (301) past a magnetic head reader. Upon reading the magnetic stripe (301) the patient's medical record identifier may be transferred into a computer capable of retrieving the patient's national and non-national medical records.

In another exemplary embodiment of the present invention, the patient's medical record identifier may be contained in barcode format (401) imprinted on a card (402). The barcode may be an optical machine-readable representation of the patient's medical record identifier. A computer capable of retrieving the patient's medical records may scan the barcode (401) to obtain the patient's medical record identifier.

In yet another exemplary embodiment of the present invention, the patient's medical record identifier may be contained in a Quick Response (QR) (501) code imprinted on a card (502). A QR code is well known in the prior art and is a specific two-dimensional matrix that is readable by QR barcode readers. A computer capable of retrieving the patient's medical records may read the QR code (501) to obtain the patient's medical record identifier.

In yet another exemplary embodiment of the present invention, the patient's medical record identifier may be contained in an Integrated Circuit (IC) chip (601) embedded within a card (602). The IC chip may be machine-readable and may store other information contained on the card (602). A computer capable of retrieving the patient's medical records may read the IC chip (601) to obtain the patient's medical record identifier.

In yet another exemplary embodiment of the present invention, the patient may recite a medical record identifier to a requesting provider. The provider may then enter the identifier into a computer capable of retrieving the patient's medical records.

The medical record identifier may be a sequence of numbers, letters, or an alphanumeric combination. The identifier may be phrase or password known to the patient and transferred to healthcare providers upon request. The identifier may also be a machine-readable sequence of bits stored in tangible form such as, but not limited to, the exemplary embodiments previously described. The identifier may be a biometric identifier that stores a measurable physical or behavioral characteristic of a patient, which can be used to verify the identity of that patient. Common biometrics includes facial recognition, fingerprints, and iris scans. The biometric used as a medical record identifier may be any biometric or combination of biometrics capable of verifying the identity of the patient.

At least some of the above described example methods and/or apparatus may be implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of this disclosure are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method for retrieving medical records comprising the steps of:
obtaining a medical record identifier from a patient;
inputting the medical record identifier into a computer capable of accessing medical records databases;
accessing a national healthcare system records database;
accessing a non-national healthcare system records database;
using the medical record identifier to locate the patient's medical records within the national healthcare system records database;
using the medical record identifier to locate the patient's medical records within the non-national healthcare system records database; and
returning the located medical records.

2. The method of claim 1, wherein the national healthcare system records database is a database containing medical records generated by healthcare providers associated with a national healthcare system.

3. The method of claim 1, wherein the non-national healthcare system records database is a database containing medical records generated by healthcare providers not associated with a national healthcare system.

4. The method of claim 1, wherein the medical records are records containing information about the healthcare condition of the patient.

5. The method of claim 1, wherein returning the located medical records includes transmitting the located medical records to the computer capable of accessing medical records databases.

6. The method of claim 1, further comprising using the located medical records to provide healthcare to the patient.

7. A system for retrieving medical records comprising:
a medical records identifier;
a national healthcare system records database;
a non-national healthcare system records database;
a computer information system capable of accessing the national healthcare system records database and capable of accessing the non-national healthcare system records database;
wherein the computer information system accesses the national healthcare system records database and the non-national healthcare system records database;
wherein the computer information system uses the medical records identifier to locate the patient's medical records in the national healthcare system records database and in the non-national healthcare system records database; and
wherein the located records are returned.

8. The system of claim 7, wherein the medical records identifier is an identifier that is unique to a patient.

9. The system of claim 7, further comprising a healthcare provider causing the computer information system to access the national and non-national healthcare system records databases.

10. The system of claim 7, wherein the located medical records may be any plurality of records from the national or non-national healthcare system records databases.

11. The system of claim 7, wherein the computer information system may consist of any plurality of computers connected by communication interfaces.

12. The system of claim 7, further comprising a healthcare provider reviewing the located medical records to provide healthcare to the patient.

13. The system of claim 12, wherein the healthcare provider is any individual or entity capable of providing healthcare services.

14. A method for retrieving medical records comprising the steps of:
obtaining from a patient a medical record identifier;
transferring the medical record identifier into a computer capable of accessing a national healthcare system records database and a non-national healthcare system records database;
using the medical record identifier to identify zero or more records in the national or non-national healthcare system records databases; and
returning the identified medical records.

15. The method of claim 14, wherein the national healthcare system records database is a database containing medical records generated by healthcare providers associated with a national healthcare system.

16. The method of claim 14, wherein the non-national healthcare system records database is a database containing medical records generated by healthcare providers not associated with a national healthcare system.

17. The method of claim 14, wherein the computer may be a computer connected by a communications interface to the national healthcare system records database and the non-national healthcare system records database.

18. The method of claim 14, wherein the medical records are records containing information about the healthcare condition of the patient.

19. The method of claim 14, wherein returning the identified medical records includes transmitting the identified medical records to the computer capable of accessing medical records databases.

20. The method of claim 14, further comprising using the identified medical records to provide healthcare to the patient.
